(19) United States
(12) Patent Application Publication
(10) Pub. No.: US 2014/0143244 A1
(43) Pub. Date: May 22, 2014

(54) METHOD AND APPARATUS FOR SEARCHING FOR CONTENT WITHIN A CHANNEL BASED ON CONTEXTUAL CHARACTERISTICS

(71) Applicants: Sailesh Kumar Satish, Tampere (FI); Jian Tang, Beijing (CN)

(72) Inventors: Sailesh Kumar Satish, Tampere (FI); Jian Tang, Beijing (CN)

(73) Assignee: NOKIA CORPORATION, Espoo (FI)

(21) Appl. No.: 14/125,466

(22) PCT Filed: Jun. 16, 2011
(86) PCT No.: PCT/CN2011/075799

§ 371 Date: Dec. 11, 2013

(51) Int. Cl. G06F 17/30

(52) U.S. Cl. CPC G06F 17/30867
USPC 707/728

(57) ABSTRACT

A method, apparatus and computer program product are provided to conduct a search within one or more channels and to produce search results based not only upon one or more search tokens, but also contextual characteristics, such as contextual characteristics provided by a user and/or contextual characteristics associated with the one or more channels. For example, a method is provided that receives input defining a search to be conducted within at least one channel. The input defining the search includes at least one search token and at least one context element. The method also causes a search request to be issued that includes a description of the search. Further, the method receives search results based upon the at least one search token and a combination of the at least one context element that was received and/or at least one context element that is defined by the respective channel.

### TECHNOLOGICAL FIELD

An example embodiment of the present invention relates generally to techniques for searching for content within a channel and, more particularly, relates to an apparatus, a method and a computer program product for searching for content within a channel based on contextual characteristics.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular are those of location based services and other personalized services. In this regard, some technologies may provide users of properly equipped mobile terminals with content that is specific to the present location of the user. Thus, for example, the user may be provided with weather information relating to the user's present location. As such, content may be provided to the user which may be relevant to the user's interests and current context. However, it may still be possible to improve the provision of content to users including the relevancy of the content.

### BRIEF SUMMARY

A method, apparatus and computer program product are therefore provided in accordance with an example embodiment in order to improve the manner in which relevant content is identified and provided, such as by providing more relevant content. In this regard, the method, apparatus and computer program product of an example embodiment are configured to conduct a search within one or more channels and to produce search results based not only upon one or more search tokens, but also contextual characteristics, such as contextual characteristics provided by a user and/or contextual characteristics associated with the one or more channels.

In an example embodiment, a method is provided that receives input defining a search to be conducted within at least one channel. The input defining the search includes at least one search token and at least one context element. In one embodiment, the input defining the search identifies the at least one channel within which the search is to be conducted and/or defines a constraint upon the search. The method also causes a search request to be issued that includes a description of the search. Further, the method receives search results based upon the at least one search token and at least one of the at least one context element that was received and at least one context element that is defined by the respective channel.

A method according to an example embodiment may receive the search results that are based upon a weighting of the at least one context element. In one embodiment, the weighting may be based upon a weight for a respective context element that is defined by the respective channel. In another embodiment, the input may include a weight associated with the at least one context element. As such, the method of this embodiment may receive the search results that are based upon a weighting of the at least one context element with the weighting based upon a combination of the weight that was received in association with a respective context element and a weight for the respective context element that is defined by the respective channel.

In an additional example embodiment, an apparatus is provided that includes at least one processor and at least one memory including computer program code with the at least one memory and the computer program code being configured to, with the processor, cause the apparatus to receive input defining a search to be conducted within at least one channel. The input defining the search includes at least one search token and at least one context element. In one embodiment, the input defining the search identifies the at least one channel within which the search is to be conducted and/or defines a constraint upon the search. The at least one memory and the computer program code are configured to, with the processor, cause the apparatus to also cause a search request to be issued that includes a description of the search. Further, the at least one memory and the computer program code are configured to, with the processor, cause the apparatus to receive search results based upon the at least one search token and at least one of the at least one context element that was received and at least one context element that is defined by the respective channel.

The at least one memory and the computer program code of one example embodiment are configured to, with the processor, cause the apparatus to receive the search results that are based upon a weighting of the at least one context element. In one embodiment, the weighting may be based upon a weight for a respective context element that is defined by the respective channel. In another embodiment, the input may include a weight associated with the at least one context element. As such, the at least one memory and the computer program code of this embodiment may be configured to, with the processor, cause the apparatus to receive the search results that are based upon a weighting of the at least one context element with the weighting based upon a combination of the weight that was received in association with a respective context element and a weight for the respective context element that is defined by the respective channel.

In a further example embodiment, a computer program product is provided that includes at least one computer-readable storage medium having computer-executable program code portions stored therein with the computer-executable program code portions including program code instructions for receiving input defining a search to be conducted within at least one channel. The input defining the search includes at least one search token and at least one context element. The computer-executable program code portions may also include program code instructions for causing a search request to be issued that includes a description of the search. Further, the computer-executable program code portions may include program code instructions for receiving search results based upon the at least one search token and at least one of the at least one context element that was received and at least one context element that is defined by the respective channel.

In yet another example embodiment, an apparatus is provided that comprises means for receiving input defining a search to be conducted within at least one channel. The input defining the search includes at least one search token and at least one context element. The apparatus also includes means for causing a search request to be issued that includes a description of the search. Further, the apparatus includes means for receiving search results based upon the at least one search token and a combination of the at least one context element that was received and at least one context element that is defined by the respective channel.

In an example embodiment, a method is provided that receives a search request for a search to be conducted within at least one channel. The search request includes at least one search token and at least one context element. The method also modifies the search request based upon characteristics of the channel including at least one context element and an associated weight defined by the respective channel. The method further causes search results to be provided based upon the at least one search token and a weighted combination of at least one of the at least one context element that was received with the search request and the at least one context element that is defined by the respective channel.

The method of one embodiment also conducts a search within the at least one channel in accordance with the search request as modified. In an embodiment in which the search request includes a constraint upon the search, the search is conducted subject to the constraint. The method may also filter the search results based upon the weighted combination of one or more context elements. In an embodiment in which the search request includes a weight associated with the at least one context element, the method may modify the search request by modifying the search request based upon a weighting that is dependent upon a combination of the weight that was received with the search request and the weight for the respective context element that is defined by the respective channel. In one embodiment, the method may modify the search request based upon characteristics of the channel by overriding at least one user preference provided with the search request.

In an additional example embodiment, an apparatus is provided that includes at least one processor and at least one memory including computer program code with the at least one memory and the computer program code being configured to, with the processor, cause the apparatus to receive a search request for a search to be conducted within at least one channel. The search request includes at least one search token and at least one context element. The at least one memory and the computer program code are also configured to, with the processor, cause the apparatus to modify the search request based upon characteristics of the channel including at least one context element and an associated weight defined by the respective channel. The at least one memory and the computer program code are further configured to, with the processor, cause the apparatus to cause search results to be provided based upon the at least one search token and a weighted combination of at least one of the at least one context element that was received with the search request and the at least one context element that is defined by the respective channel.

The at least one memory and the computer program code being configured to, with the processor, cause the apparatus of one embodiment to also conduct a search within the at least one channel in accordance with the search request as modified. In an embodiment in which the search request includes a constraint upon the search, the search is conducted subject to the constraint. The at least one memory and the computer program code may also be configured to, with the processor, cause the apparatus to filter the search results based upon the weighted combination of one or more context elements. In an embodiment in which the search request includes a weight associated with the at least one context element, the at least one memory and the computer program code may be configured to, with the processor, cause the apparatus to modify the search request based upon a weighting that is dependent upon a combination of the weight that was received with the search request and the weight for the respective context element that is defined by the respective channel. In one embodiment, the at least one memory and the computer program code may be configured to, with the processor, cause the apparatus to modify the search request based upon characteristics of the channel by overriding at least one user preference provided with the search request.

In a further example embodiment, a computer program product is provided that includes at least one computer-readable storage medium having computer-executable program code portions stored therein with the computer-executable program code portions including program code instructions for receiving a search request for a search to be conducted within at least one channel. The search request includes at least one search token and at least one context element. The computer-executable program code portions also include program code instructions for modifying the search request based upon characteristics of the channel including at least one context element and an associated weight defined by the respective channel. The computer-executable program code portions further include program code instructions for causing search results to be provided based upon the at least one search token and a weighted combination of at least one of the at least one context element that was received with the search request and the at least one context element that is defined by the respective channel.

In yet another example embodiment, an apparatus is provided comprises means for receiving a search request for a search to be conducted within at least one channel. The search request includes at least one search token and at least one context element. The apparatus also includes means for modifying the search request based upon characteristics of the channel including at least one context element and an associated weight defined by the respective channel. The apparatus further includes means for causing search results to be provided based upon the at least one search token and a weighted combination of the at least one context element that was received with the search request and the at least one context element that is defined by the respective channel.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to search for content within a channel based on contextual characteristics according to an example embodiment of the present invention;

FIG. 3 illustrates a flowchart of the operations performed from the perspective of a user terminal according to an example embodiment of the present invention;

FIG. 4 is a screen display presented by the user terminal in one embodiment of the present invention in order to solicit user input to define a content search;

FIG. 5 illustrates a flowchart of the operations performed from the perspective of a content provider according to an example embodiment of the present invention; and

FIG. 6 is a block diagram of the search processing framework of a content provider in accordance with one embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

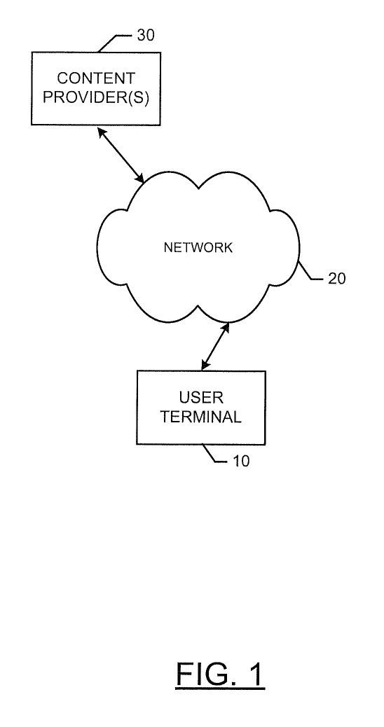

As indicated above, some embodiments of the present invention may be employed in methods, apparatuses and computer program products configured to search for content within a channel based on contextual characteristics. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 20. The network 20 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 20. Although not necessary, in some embodiments, the network 20 may be capable of supporting communication in accordance with any one or more of a number of first-generation (1G), second-generation (2G), 2.5G, third-generation (3G), 3.5G, 3.9G, fourth-generation (3G) mobile communication protocols, Long Term Evolution (LTE), and/or the like. Thus, the network 20 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 20. By directly or indirectly connecting the user terminal 10 and the other devices to the network 20, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 20 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 20 may be a home network or other network providing local connectivity.

The user terminal 10 may be configured to request, receive, and output Uniform Resource Locators (URLs), text, pictures, data, audio, video, and/or various other embodiments and media formats of content. In some embodiments the content may be provided to the user terminal 10 by one or more content providers 30. One or more of the content providers 30 may be embodied as a server, server bank or other computer or other computing device or node configured to provide content segments to the user terminal 10. Each of the content providers 30 may have any number of functions or associations with various services. As such, for example, one or more of the content providers 30 may be a platform such as a dedicated server (or server bank), or one or more of the content providers may be a backend server associated with one or more other functions or services. Thus, the content providers 30 may provide content to the user terminal 10 for use by a user thereof. A content provider 30 may also be a service provider.

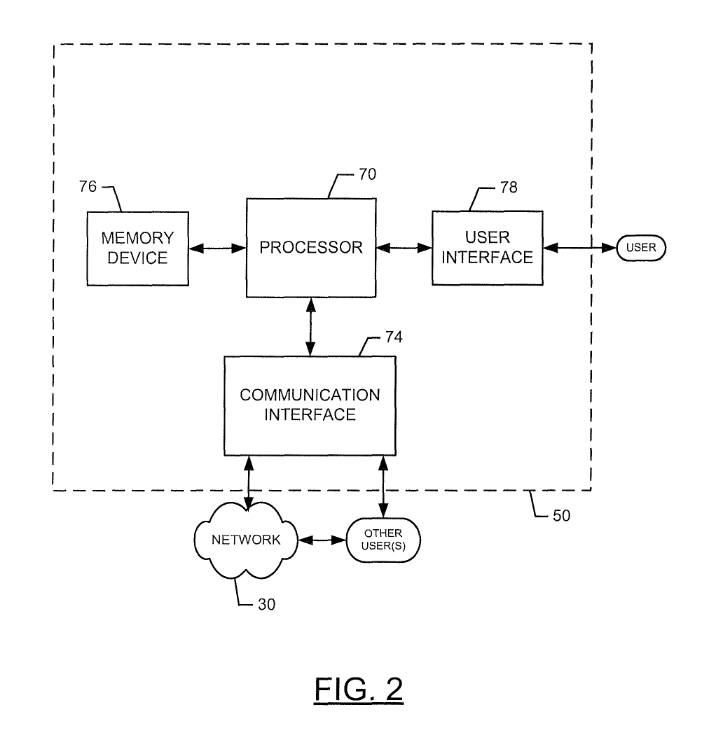

In an example embodiment illustrated in FIG. 2, an apparatus 50 is provided that may be employed by devices performing example embodiments of the present invention. The apparatus 50 may be embodied, for example, as any device hosting, including, controlling, comprising, or otherwise forming a portion of the user terminal 10 and/or the content provider(s) 30. However, embodiments may also be embodied on a plurality of other devices such as for example where instances of the apparatus 50 may be embodied on the network 20. As such, embodiments of the apparatus 50 illustrated in FIG. 2 are merely examples and may include more, or in some cases less, than the components shown in FIG. 2.

With further regard to FIG. 2, the apparatus 50 may be configured to facilitate the search for content within a channel based on contextual characteristics, such as contextual characteristics provided by the user and/or contextual characteristics that are introduced by the channel. As depicted in FIG. 2, the apparatus 50 may include or otherwise be in communication with a processor 70, a communication interface 74, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal 10, such as a mobile or fixed communication device or computing device configured to employ an example embodiment of the present invention, while in other embodiments, the apparatus 50 may be a content provider 30, such as a server. However, the apparatus 50 may be embodied as a chip or chip set which may, in turn, constitute a portion of a user terminal 10 or a content provider 30. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

As mentioned above, embodiments of the apparatus 50 may include more, or in some cases less, than the components shown in FIG. 2. In this regard, the apparatus 50 may also include a user interface 78, such as in an instance in which the apparatus is embodied as a user terminal 10. In an instance in which the apparatus 50 is embodied as a content provider 30, however, the apparatus need not include a user interface 78 or the user interface may be somewhat limited. In an embodiment in which the apparatus 50 includes a user interface 78, the user interface may be in communication with the processor 70 to receive an indication of a user input at the user interface and/or to provide an audible, visual, mechanical or other output to the user. As such, the user interface 78 may include, for example, a keyboard, a mouse, a joystick, a display, a touch screen, a microphone, a speaker, or other input/output mechanisms.

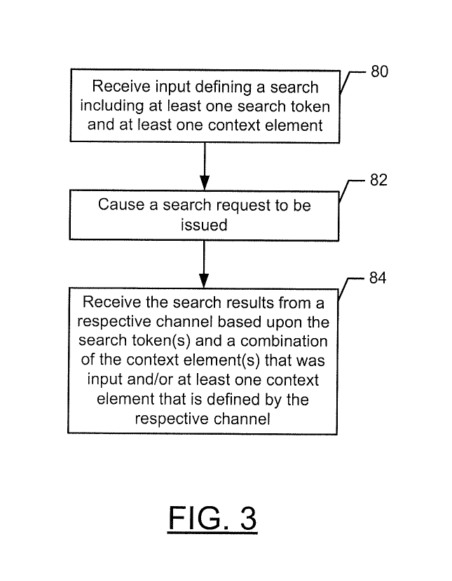

Referring now to FIG. 3, the operations performed by an apparatus 50 of one example embodiment that comprises a portion of or is embodied as a user terminal 10 are shown. As shown in block 80, the apparatus includes means, such as the processor 70, the user interface 78 or the like, for receiving input that defines a search to be conducted within a channel. A channel, as used herein, may refer to a content channel that includes or has access to a source or collection of content segments that relate to one or more topics. By way of example, channels may provide content segments relating to sports, news, nearby restaurants, nearby events, etc., and may come in one or more various types of media formats. However, one or more of the channels may be generic with a generic channel providing random content segments. In some embodiments, the channels may provide content segments to the user terminal 10 in the form of uniform resource locators (URLs) that are selectable by the user. However, a user terminal 10 may output other types of content segments in other forms.

The input that is received to define the search may include various parameters including, for example, one or more search tokens and one or more context elements. The search tokens may include words, phrases or other strings of one or more characters that may be utilized by the content provider 30 so as to identify those content segments that include the search tokens. The context element that is received by the apparatus 50 may be any of various context elements associated with the user and/or the user terminal 10. For example, the context element may identify the current location of the user terminal 10, the current day and time, the current mode of transportation, if any, of the user terminal, the current activity in which the user is involved, etc. In addition to the search token(s) and the context element(s), the input that is received so as to define the search may include other elements, such as the identification of one or more channels within which the search is to be conducted and/or one or more constraints upon the search. Various constraints may be placed upon the search including an expiration time such that the search is only conducted prior to the expiration time, a location such that the search is only conducted while the apparatus remains with the location, a context, e.g., transportation on a bus, such that the search is only conducted while the context remains the same. In one embodiment, combinations of the various constraints may be placed upon the search. By way of example in which the search is constrained by an expiration time, the expiration time may be defined in various manners including a date, a specific time or the like. In an instance in which the input that defines the search does not include an identification of the channel within which the search is to be conducted or an expiration time for the search, the search may be conducted in accordance with default values for the channel and/or the expiration time. In this regard, one or more default channels may be established in advance or otherwise predefined such that the search is conducted in the default channel(s) in an instance in which the input that defines the search does not identify a particular channel. Additionally, in an instance in which the input that defines the search does not define the expiration date for the search, the search may be conducted indefinitely, until the user terminates the search or until the search returns search results.

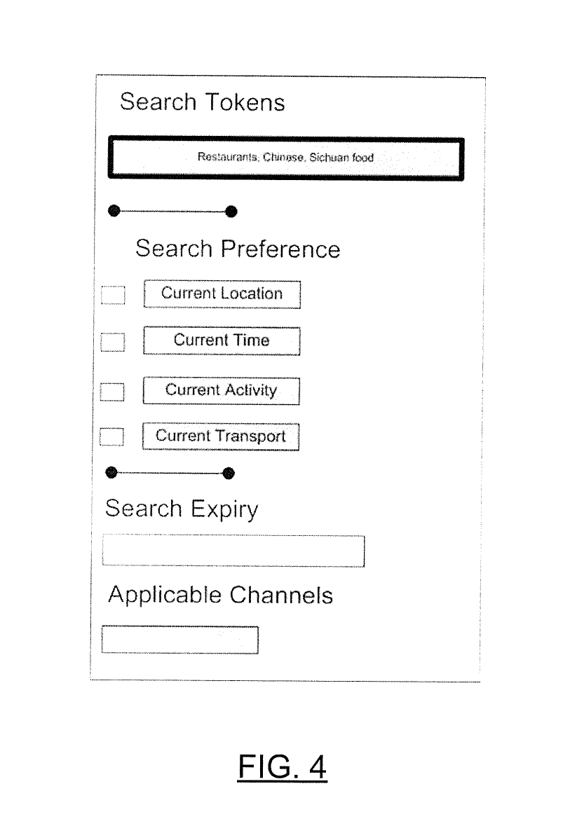

Although the input that defines the search may be entered in various manners, the apparatus 50, such as the processor 70, may be configured to cause a search definition window to be presented upon the user interface to solicit the input of the various parameters that define the search. As shown in FIG. 4, for example, a search definition window may solicit one or more search tokens, one or more context elements, the identification of one or more channels within which the search is to be conducted and/or any constraints to be placed upon the search. In the illustrated embodiment, search tokens of “Restaurants” “Chinese” and “Sichuan food” are provided, although a wide variety of other search tokens may be entered in addition to or instead of those illustrated in FIG. 4 in other embodiments.

In the embodiment of FIG. 4, four candidate context elements are displayed, namely, the current location, the current time, the current activity and the current transport, e.g., the current mode of transportation. In order to include one or more of these candidate context elements within the definition of the search, the user may simply select, such as by checking the corresponding box, one or more of the candidate context elements. However, the input that defines the search may include additional or other context elements in other embodiments. In this regard, the apparatus 50, such as a processor 70, may be configured to modify the search definition window in a dynamic manner such that each context that is currently applicable for the user terminal 10 will be displayed such that the candidate context elements may change from time to time as the context of the user terminal similarly changes.

Based upon the input that defines the search, a search request may be assembled. In this regard, the apparatus 50 may include means, such as the processor 70, the communication interface 74 or the like, for causing a search request to be issued that includes a description of the search. See operation 82 of FIG. 3. The search request generally includes the search token(s), the context element(s), the channel within which the search is to be conducted and the constraints, if any, to be placed upon the search.

Based upon the search request, the content provider 30 may then conduct the search and subsequently provide the results of the search. In the context of the user terminal 10, the apparatus 50 of one example embodiment may therefore also include means, such as the processor 70, the communication interface 74 or the like, for receiving the search results. See operation 84 of FIG. 3. In this regard, the search results are based upon the search token(s) and the context element(s) that are input via the user terminal 10 in operation 80. As described below in conjunction with the manner in which the search may be conducted by the content provider 30, the search results may be based not only on the search token(s) and the context element(s) that were received as input via the user terminal 10, but upon a combination of the context element(s) that were received as input via the user terminal and/or at least one context element that is defined by the respective channel within which the search is conducted. As also described below, the search results that are received by the user terminal 10 may be the product of weighting the various context elements in order to provide relative emphasis, or de-emphasis, to the respective context elements during the search.

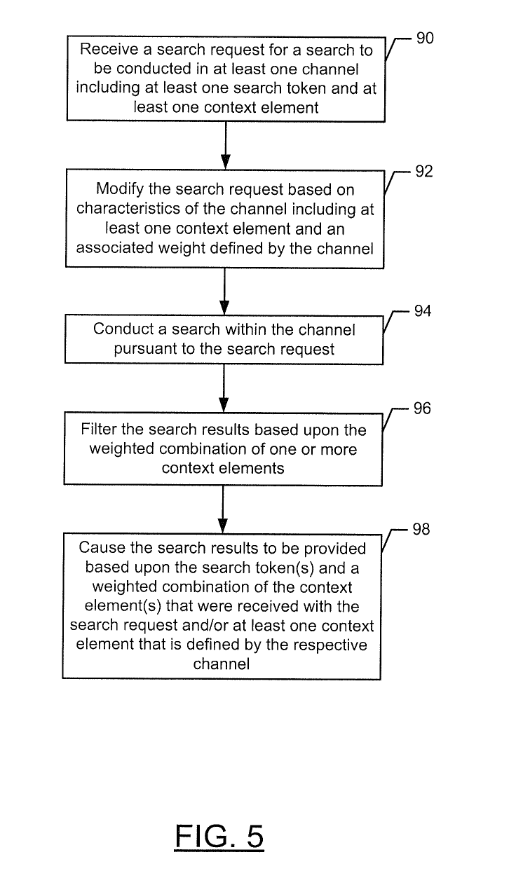

In the context of the content provider 30 and as shown in operation 90 of FIG. 5, the apparatus 50 may include means, such as the processor 70, the communication interface 74 or the like, for receiving the search request for a search to be conducted within at least one channel. The channel(s) within which the search is to be conducted may be predefined such that all searches or, at least all searches from the respective user terminal 10, are conducted within the predefined channel(s). Additionally, or alternatively, the search request may define the channel(s) within which the search is to be conducted with the search thereafter being conducted in the channel(s) that are input during the definition of the search in addition to, or instead of, the predefined channel(s). As described above in conjunction with the operations of the user terminal 10, the search request that is received by the content provider 30 may include at least one search token and at least one context element that has been input via the user terminal. Additionally, the search request may optionally include one or more constraints, such as an expiration time, for the search.

The apparatus 50 that is embodied in or comprises the content provider 30 also includes means, such the processor 70 or the like, for modifying the search request based upon characteristics of the channel in which the search is to be conducted. See operation 92 of FIG. 5. In this regard, the channel may be associated with one or more context elements. Thus, the context elements that are taken into account during the search and the provision that the search results may include not only the context element(s) that are input via the user terminal 10 during the initial definition of the search, but also one or more context elements that are associated with the channel within which the search is to be conducted. The context element(s) from the initial definition of the search and the context element(s) associated with the channel may be the same or different.

According to one embodiment, the apparatus 50, such as the processor 70, may weight the context elements, including those provided via the user terminal during 10 the initial definition of the search and those associated with the channel within which the search is to be conducted. In this regard, a weight may be associated with each or at least some of the context elements in order to control the manner in which the context elements will effect the search conducted by the content provider 30. Although the weights may be defined in various manners, the weights of one embodiment are defined such that larger positive values represent a greater weighting than smaller positive values which, in turn, represent greater weighting than negative values. Context elements with greater weighting may therefore have a greater relative impact upon the search results than context elements with lesser weighting.

With respect to the context element(s) provided via the user terminal 10 in the definition of the search, the user terminal may solicit entry of respective weights for the context element(s). For example, the search definition window of FIG. 4 may be configured such that instead of simply selecting or checking a box associated with a context element, the user may enter a weight, such as a value from 0 to 5, in association with a selected context element so as to provide the respective weight. Additionally, or alternatively, the channel within which the search is to conducted may include predefined weight(s) associated with the context element(s) that are affiliated with the channel.

In an instance which the same context element is provided via the user terminal 10 during the initial definition of search and by the channel within which the search is to be conducted, the corresponding weights for the respective context elements may be combined, such as by being added together. By way of example, a search heuristic associated with a restaurant channel that defines the predetermined characteristics of the restaurant channel is outlined below. As shown, the type of the search is initially defined as either being persistent, that is, repeating indefinitely, or non-persistent in which the search results will be returned immediately regardless of whether there is anything to report or not. Additionally, the weights of the context elements associated with the restaurant channel are defined. The search heuristic defines the weights to be additive such that the weights associated with the channel are added to the weights of any corresponding context elements that are defined by the user terminal 10 during the initial definition of the search. In this embodiment, the context elements associated with the restaurant channel include location, time and activity type, namely, whether the user terminal is in transport. Of these, the location is weighted most heavily by having a value of 2. In contrast, the context element of time has a weight of 1 and the context element of activity type, has a weight of −1. In this embodiment, a negative weighting of a context element effectively removes the respective context element from consideration during the search and the provision of the search results. Thus, the activity context element will not be considered during the search and the provision of the search results, even if the activity context element is defined as part of the original definition of the search. As exemplified by the negative weighting of this example embodiment, the apparatus 50 in the context of the content provider 30 may include means, such as the processor 70 or the like, for modifying the search request based upon characteristics of the channel by overriding at least one user preference, such as a user-provided context element, provided with the search request. Thus, the activity type context element in the above example will not be considered during the provision of the search results regardless of whether the activity type context element was included in the initial definition of this search, thereby effectively overriding the user preference based upon the characteristics of the channel.

<searchHeuristic>
<channel name=Restaurants>
<type>Persistent</type> //Persistent or Non-persistent - non-persistent
//will return immediately even if there is no result
<contextWeights type=additive> //add these weights to the appropriate
tokens
<location>2</location>
<time>1</time>
activity type=transport>−1</activity> //negative value removes those
tokens
</contextWeights>
</channel>
</searchHeuristic>

By way of another example in which a non-persistent search is conducted within an education channel, context elements of location, time, activity type, user gender and user age are associated with the education channel. As in the prior example, the context weights are additive with the most importance being given to the user age as a result of a weight of 3, with equal and a substantial weight of 2 being given to the user gender and time context elements, some weight being given to the activity type of the user terminal 10 being in transport due to a weighting of 1 and little significance being given to the location context element as a result of a weighting of 0. In this regard, the weighting of 0 allows the respective context element to be taken into account and not overridden, but without much significance being applied to the respective context element relative to other context elements.

<searchHeuristic>
<channel name=Education>
<type>Non-persistent</type> //Persistent or Non-persistent - non-
persistent will return immediately even if there is no result
<contextWeights type=additive> //add these weights to the appropriate
tokens
<location>0</location> //not much significance to location but is taken
to account and not overridden
<time>2</time> //time of day is given more importance
<activity type=transport>1</activity> //transport mode is given
importance - for example reading while traveling in bus
</contextWeights>
<userType>
<gender>2</gender> //give importance to gender related content
<age>3</age>//give higher importance to age related content
</userType>
</channel>
</searchHeuristic>

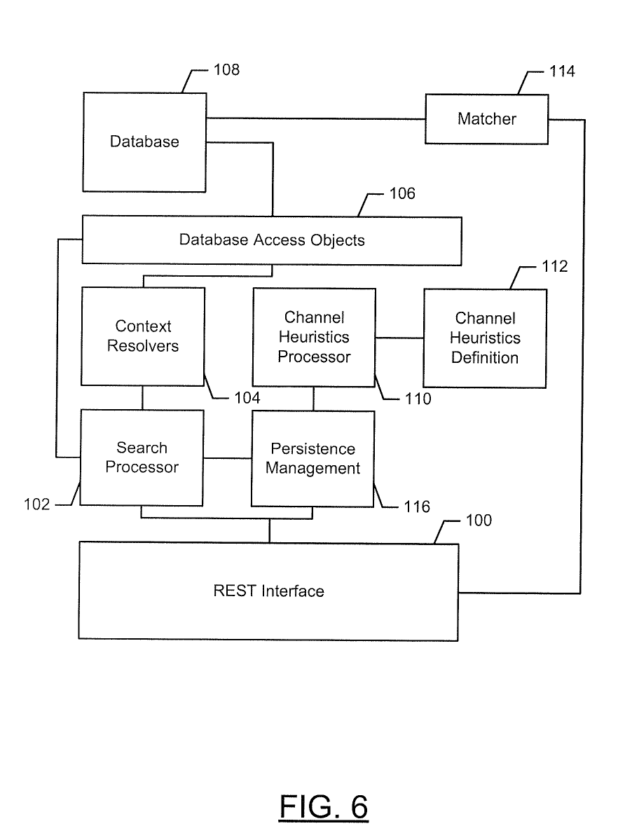

In the context of a content provider 30, the apparatus 50 may also include means, such as the processor 70 or the like, for conducting a search within the at least one channel in accordance with the modified search request to identify, for example, content segments including one or more of the search tokens. See operation 94 of FIG. 5. The apparatus 50 of this embodiment may also include means, such as the processor 70, the communication interface 74 or the like, for causing the search results to be provided based upon the at least one search token and the weighted combination of the at least one context element that was received with the search request and/or the at least one context element that was defined by the respective channel. See operation 98 of FIG. 6. In one embodiment, for example, the context elements are not utilized while conducting this search, that is, the context elements are not used as a portion of the search string. Instead, the context elements may be utilized to filter the search results such that the search results are provided to the user terminal 10 and presented to the user once the initial search results have been filtered in accordance with the weighted combination of the one or more context elements. As shown in operation 96 of FIG. 6, the apparatus 50 of this embodiment may therefore include means, such as the processor 70 or the like, for filtering the search results based upon the weighted combination of the context element(s). Thus, the search results that are aligned or otherwise consistent with the context elements, such as the more greatly weighted context elements, will be provided to the user terminal 10, typically in a preferential position, such as at or near the top of the listing of search results. In contrast, search results that are misaligned or otherwise do not satisfy one or more of the context elements, such as the more greatly weighted context elements, will either not be provided to the user terminal 10 or will be provided in a non-preferred manner, such as at or toward the bottom of a listing of the search results.

As described above, in an embodiment in which context elements are provided both via the user terminal 10 during the initial definition of the search and in association with the channel in which the search is conducted, the context elements that are considered during the provision of the search result are a combination, that is, a superset, of the context elements provided via the user terminal during the initial definition of the search and/or the context elements that are associated with the channel. In instances in which the context elements are weighted and in which the same context element is provided both via the user terminal 10 during the initial definition of the search and in association with the channel, the weighting of the respective context element is dependent upon a combination of the weight that was received with the search request and the weight of the respective context element as defined by the respective channel. For example, the weight of a context element that was received with the search request and the weight for the respective context element that is defined by the respective channel may be added together.

The search results may be provided in various manners. In one embodiment, the search results identify the name of the channel as well as the context element(s) and the search token(s) that were considered during the search in addition to providing the results of the search. By way of example, the search results that may be provided following a search within the restaurant channel utilizing search tokens of “Chinese Restaurant” and context elements of location and time are shown below.

<search>
<channel name=“restaurant”>
<location><lat>..</lat><lon></lon></location> //context used in search
<time>morning</morning> //context used in search
<searchTokens> Chinese restaurant</searchTokens> //search tokens that
the user had provided
<result>...............</result> //result of the search
</channel>
</search>

As indicated above, the search may be conducted in a non-persistent manner such that the search is conducted and then concluded with the provision of the search results regardless of whether the search results include any entries or not. Other searches may be conducted in a persistent manner. For example, the search may be repeatedly conducted until an expiration time that is provided during the initial definition of the search. In this embodiment, search results may be repeatedly provided and updated as the context of the user terminal 10 and/or the content that is searched changes. As such, in this embodiment, the apparatus 50 of the user terminal 10 may include means, such as the processor 70, the communication interface 74 or the like, for monitoring the context of the user terminal and for providing an update to the content provider 30 of the context in an instance in which the context has changed from the context that was previously reported, thereby altering the search conducted by the content provider. Alternatively, the search may be repeatedly conducted until search results are returned at which time the search is concluded regardless of the expiration time, if any, associated with the search. In this embodiment, the apparatus 50 of the user terminal 10 may also provide updated context to the content provider 30 in an instance in which the context of the user terminal has changed, thereby potentially altering the results of the search to be conducted by the content provider.

As noted above, the search results may be provided in various manners. In one embodiment, however, the content provider 30 is configured so as to cause the search results to be separately provided for each channel within which the search is conducted. In this regard, the search results from each channel may differ, not only based upon the different content that is searched within the different channels, but also based upon the different characteristics of the channels within which the search is conducted including different context elements and different weightings of the context elements.

The content provider 30 may be configured in various manners in order to conduct the search within one or more channels. In one embodiment, the interface to the server or other computing device that functions as the content provider 30 may be Representational State Transfer (REST)-based such that the user terminal 10 may provide a search request via the REST-based interface 100 to a search processing engine of the server. By way of example, but not of limitation, FIG. 6 illustrates the search processing framework of the content provider 30 in accordance with one embodiment. As described below, the search processing framework includes various functional modules, all or some of which may be embodied by the processor 70 of the embodiment of FIG. 2.

In the embodiment of FIG. 6, however, the REST interface 100 may be configured to pass the body of the search request, such as in an extensible markup language (XML) format or other format, to a search processor 102. The search processor 102 may be configured to process the body of the search request and to extract the context tokens, that is, the context elements and the priority data, such as the weightings associated with the context elements. The search processor 102 may also be configured to utilize context resolvers 104 and data access objects 106 (DAO) to extract tokens related to the context from the database 108. The DAO 106 may be configured to provide access to the database 108 so that the database may be modified without requiring the interfaces that access the database to be modified. Once the tokens related to context are extracted, the priority information, such as the weightings, is added to the tokens and then passed to a channel heuristics processor 110.

The channel heuristics processor 110 of this embodiment may be configured to parse the predefined channel heuristics definitions 112 for the channels to be searched and to assign weights to the context elements based on the preferences expressed by the user during the definition of the search request and/or based upon the weights of the context elements that are defined by the channel heuristics definitions for the channel(s) within which the search is to be conducted. Once the weights have been assigned to the context elements, the tokens representative of the weighted context elements may be passed back to the search processor 102. The search processor 102 may also be configured to assign weights to the search tokens entered via the user terminal 10 during the initial definition of the search. The entire set of tokens representative of the context elements and the search tokens along with the respective weights may then be passed to the matcher module 114 to perform the search within the database 108. If a search result is obtained, the result may be provided to the user terminal 10. If no result is obtained, however, the search tokens may be maintained by a persistence management module 116. In some embodiments, even if a search is obtained, the search tokens may be maintained by the persistence management module 116 and the search may be repeated until the expiration time has been reached. In other embodiments, however, if an expiration time has not been set and search results have been obtained, the search may be deemed to have been successfully processed and the search tokens may not be passed to the persistence management module 116. In an instance in which the search is going to be repeatedly conducted, the search processor 102 may be configured to pass the search parameters, that is, the original search request but not the extracted tokens, to the persistence management module 116 along with the persistence information, such as the expiration time, channel information, such as a list of channels to which the search applies, and user account information such as a unique identifier or user identifier.

In an instance in which the content provider 30, such as a server or other computing device, receives a GET request including a search request for content from the user terminal 10, the REST interface 100 may be configured to process the search request and to forward the search request to the appropriate processing modules as described above in regards to the embodiment of FIG. 6. The search request may include channel information defining the channel within which the search is to be conducted and user account information. The module that processes the particular request may forward the context of the user terminal 10, the channel information and the user account information to the persistence management module 116. The persistence management module 116 may be configured to determine if there is a valid channel specific search request that is already configured and operative for the respective user terminal 10. If so, the persistence manager module 116 may be configured to transmit an updated request for the search to the search processor 102 with the new context data provided by the user included in the search parameters. If a search result is obtained in accordance with the new context tokens and the new search parameters, the search result may be packaged, such as in an XML format, and embedded along with the results of the GET request. In some embodiments, the content provider 30 may cause the search results for other channels to be sent as well as the channel that the user terminal 10 is currently utilizing.

In some embodiments, the user terminal 10 may be configured to send a separate GET request to the content provider 30 to determine whether there are any results for a prior search request. This GET request may be invoked by the user or the user terminal 10 may repeatedly issue such a GET request. If a request for a search is received by the content provider 30 and there are no valid persistent searches available, the content provider may be configured to respond with an appropriate message indicating to the user terminal 10 that there is no valid search request present at the content provider.

As described above, methods, apparatus and computer program products of an example embodiment of the present invention provide search results tailored to the search request provided by a user terminal 10 and as modified by the contextual characteristics of the channel within which the search is being conducted including, for example, updated search results as the context of the user terminal 10 changes as a result of the persistence of the search. While the user terminal 10 may be a fixed terminal, the methods, apparatus, computer program product of embodiment of the present invention may be useful in conjunction with a mobile terminal as the context associated with the mobile terminal may change more frequently and therefore may merit updated search results.

As described above, FIGS. 3 and 5 are flowcharts of an apparatus, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving input defining a search to be conducted within at least one channel, wherein the input defining the search comprises at least one search token and at least one context element;
causing a search request to be issued by a processor that includes a description of the search; and
receiving search results based upon the at least one search token and at least one of the at least one context element that was received and at least one context element that is defined by the respective channel.

2. A method according to claim 1 wherein receiving the input comprises receiving input identifying the at least one channel within which the search is to be conducted.

3. A method according to claim 1 wherein receiving the input comprises receiving input defining a constraint upon the search.

4. A method according to claim 1 wherein receiving the search results comprises receiving the search results based upon a weighting of the at least one context element with the weighting based upon a weight for a respective context element that is defined by the respective channel.

5. A method according to claim 1 wherein receiving the input comprises receiving a weight associated with the at least one context element.

6. A method according to claim 5 wherein receiving the search results comprises receiving the search results based upon a weighting of the at least one context element with the weighting based upon a combination of the weight that was received in association with a respective context element and a weight for the respective context element that is defined by the respective channel.

7. An apparatus comprising at least one processor and at least one memory including computer program code, the at least one memory and the computer program code configured to, with the processor, cause the apparatus to:
receive input defining a search to be conducted within at least one channel, wherein the input defining the search comprises at least one search token and at least one context element;
cause a search request to be issued that includes a description of the search; and
receive search results based upon the at least one search token and at least one of the at least one context element that was received and at least one context element that is defined by the respective channel.

8. An apparatus according to claim 7 wherein the at least one memory and the computer program code are configured to, with the processor, cause the apparatus to receive the input by receiving input identifying the at least one channel within which the search is to be conducted.

9. An apparatus according to claim 7 wherein the at least one memory and the computer program code are configured to, with the processor, cause the apparatus to receive the input by receiving input defining a constraint upon the search.

10. An apparatus according to claim 7 wherein the at least one memory and the computer program code are configured to, with the processor, cause the apparatus to receive the search results by receiving the search results based upon a weighting of the at least one context element with the weighting based upon a weight for a respective context element that is defined by the respective channel.

11. An apparatus according to claim 7 wherein the at least one memory and the computer program code are configured to, with the processor, cause the apparatus to receive the input by receiving a weight associated with the at least one context element.

12. (canceled)

13. (canceled)

14. A method comprising:
receiving a search request for a search to be conducted within at least one channel, wherein the search request comprises at least one search token and at least one context element;
modifying, with a processor, the search request based upon characteristics of the channel including at least one context element and an associated weight defined by the respective channel; and
causing search results to be provided based upon the at least one search token and a weighted combination of at least one of the at least one context element that was received with the search request and the at least one context element that is defined by the respective channel.

15. A method according to claim 14 further comprising conducting a search within the at least one channel in accordance with the search request as modified.

16. A method according to claim 15 wherein the search request includes a constraint upon the search, and wherein conducting the search comprises conducting the search subject to the constraint.

17. A method according to claim 15 further comprising filtering the search results based upon the weighted combination of one or more context elements.

18. A method according to claim 14 wherein the search request includes a weight associated with the at least one context element, and wherein modifying the search request comprises modifying the search request based upon a weighting that is dependent upon a combination of the weight that was received with the search request and the weight for the respective context element that is defined by the respective channel.

19. A method according to claim 14 wherein modifying the search request based upon characteristics of the channel comprises overriding at least one user preference provided with the search request.

20. An apparatus comprising at least one processor and at least one memory including computer program code, the at least one memory and the computer program code configured to, with the processor, cause the apparatus to:
receive a search request for a search to be conducted within at least one channel, wherein the search request comprises at least one search token and at least one context element;
modify the search request based upon characteristics of the channel including at least one context element and an associated weight defined by the respective channel; and
cause search results to be provided based upon the at least one search token and a weighted combination of at least one of the at least one context element that was received with the search request and the at least one context element that is defined by the respective channel.

21. An apparatus according to claim 20 wherein the at least one memory and the computer program code are further configured to, with the processor, cause the apparatus to conduct a search within the at least one channel in accordance with the search request as modified.

22. (canceled)

23. (canceled)

24. An apparatus according to claim 20 wherein the search request includes a weight associated with the at least one context element, and wherein the at least one memory and the computer program code are configured to, with the processor, cause the apparatus to modify the search request by modifying the search request based upon a weighting that is dependent upon a combination of the weight that was received with the search request and the weight for the respective context element that is defined by the respective channel.

25. (canceled)
